(19) United States
(12) Patent Application Publication
(10) Pub. No.: US 2024/0057819 A1
(43) Pub. Date: Feb. 22, 2024

(54) APPARATUS, SYSTEM AND METHOD FOR FOOD WASHING AND PREPARATION

(71) Applicants: Griffin Edward Kelly, Chicago, IL (US); Susie Kelly, Chicago, IL (US)

(72) Inventors: Griffin Edward Kelly, Chicago, IL (US); Susie Kelly, Chicago, IL (US)

(21) Appl. No.: 18/453,510

(22) Filed: Aug. 22, 2023

Related U.S. Application Data
(60) Provisional application No. 63/399,750, filed on Aug. 22, 2022.

(51) Int. Cl. A47J 43/24; A47J 43/08

(52) U.S. Cl. CPC A47J 43/24; A47J 43/082

(57) ABSTRACT

A washing apparatus that is used to clean and prepare foods for human consumption. Best used with rice, the system helps to make the cleaning process simpler. The system is composed of a container which can be filled with water. A strainer, which can be inserted into the container, which can be filled with rice. A spatula, paddle, or other such shape which is used as an agitator of the rice and water to facilitate cleaning, which is inserted into the strainer. A lid with a hole, which attaches to the top of the container to seal the rice & water inside of the container, and limit splashing, but exposes the top of the paddle. A handle, which can be attached to the top of the paddle, to allow the paddle to rotate around the strainer.

### CROSS REFERENCE TO RELATED APPLICATION

The application claims priority to U.S. Provisional Patent Application No. 63/399,750, filed on Aug. 22, 2022, entitled “RICE WASHING APPARATUS, SYSTEM AND METHOD,” the content of which is incorporated by reference herein in its entirety.

### FIELD OF TECHNOLOGY

The present disclosure generally relates to food washing and preparation, and in particular rice washing. Exemplary embodiments disclosed herein find particular application in conjunction with rice washing and its preparation for the purpose of consumption, and they will be described herein with particular reference thereto. It is also to be appreciated that various exemplary embodiments such as those disclosed herein are also amenable to other like applications and/or other types of foods, e.g., such as legumes, grains, vegetables, and, or, salads, as well as alternative forms of processing such as preparation, washing, soaking, sprouting, and/or cooking.

### BACKGROUND

Rice is washed as a part of the preparation process of cooking, as to create a more desirable texture by removing residual particulates from the milling process such as dusts of the hull, bran, or germ layers. More generally described as free starches, when they are mixed with water, the free starches turn into a ‘glue’ that clumps the cooked rice. By washing the rice and removing these free starches one can prepare a fluffier rice, one where each grain is less likely to stick to the neighboring kernel.

Washing rice can remove and reduce arsenic that is naturally found in rice from specific regions of the world; excessive arsenic intake can lead to health problems, such as breathing and swallowing problems, as well as liver and kidney damage. While arsenic intake is a particular problem, more generally, pesticides and herbicides are used in the growing process of nearly all grains and vegetables and pose a similar risk to human health. By washing these foods, one can greatly reduce the amount of residual surface pesticides before ingesting them.

The water from the rice washing process is most commonly drained, and not reused, but there have been new suggestions on better uses to recycle the water. Anecdotal evidence has found that it can strengthen hair and has numerous skin benefits. Additionally, it has been suggested as a fertilizer for plants or a means to water them.

To wash the rice, techniques currently suggest to fill a bowl with rice, pour water into the bowl, agitate the rice with one's fingers, discard the excess water, and repeat the process until the water runs clear. Similar techniques are used for other foods, such as running water over the food, soaking or dunking the food in water and agitating the water and foods simultaneously. This process is tedious and laborious, subject to excessive water use, loss of rice grains down the drain, and requires that the preparer soak their hands in the rice-which can be unhygienic.

Some conventional systems have been developed which use mechanical systems to clean foods and more specifically, rice:
U.S. Patent Application Publications, Publication Nos.: US 20100263555A1; US 20160045072A1, US 20190069727A1
C.N Patent Application Publications, Publication Nos.: CN111227681A, CN103637366A
J.P Patent Application Publications, Publication Nos: JP 2005245934A

However, many prior art food washers have exhibited some form of flaw, drawback, limitation and/or other undesirable characteristic. Most notably, previous designs have not accounted for the tendencies of rice and/or other grains and/or foods to stick to washers nor have they created a method to ensure all grains are transferred to the intended cooking vessel; similarly, they have failed to account for the small size of rice grains, which can easily slip between filters or grating if the filter pores or grates, respectfully, are too large. Additionally, they have not attempted to limit or reduce the amount of water, or solvent, used in the cleaning process. Subsequently these prior art food washers may lead to rice granule damage due to excessive and/or improper agitation.

Accordingly, there is a need for an improved apparatus, system, and device for food washing and preparation.

### BRIEF SUMMARY OF THE INVENTION

Among other features, the present disclosure generally relates to a portable washing apparatus that includes a handle, lid, paddle or spatula, strainer or filter, and container. In one embodiment, the apparatus may be assembled by inserting the strainer into the container, inserting the spatula, or paddle, into the strainer, attaching the lid to the container, and attaching the lid to the paddle through a hole in the lid. The strainer may be configured to house the paddle which sits in the base of the container, allowing the handle to be cranked in a circular motion repetitively.

Rice or other foods are to be placed inside of the strainer during assembly, and the container filled with water. Once fully assembled with rice or other food, the paddle may be rotated by way of the cranking continually in a 360 degree manner, and the rice or other food is agitated and subsequently cleansed by means of thorough mixing with water. Subsequently, the rice, or other food, is cleansed of any particulates. As a result, dust, arsenic, free starches, residue, and/or pesticides may be washed off.

When the user has concluded washing, the handle and lid are removed; the strainer, which contains the rice, may be removed from the container; and the container holding the water drained. The rice may then be poured into the intended cooking vessel such as a pot or rice cooker. The paddle may be configured to brush off any remaining rice grains that may stick to the strainer by sweeping them into the intended cooking vessel. In this way, no rice is lost in the drain, and water is conserved as the typical washing cycle using the washing apparatus requires less water than required when using traditional hand washing methods.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplary pointed out in the claims.

### BRIEF DESCRIPTION OF THE DRAWINGS

The following Detailed Description makes reference to the figures in the accompanying drawings. However, the inventive subject matter disclosed herein may take form in various components and arrangements of components, and in various steps and arrangements of steps. The drawings are only for purposes of illustrating exemplary and/or preferred embodiments and are not to be construed as limiting. Further, it is to be appreciated that the drawings may not be to scale.

FIG. 1 is a perspective view of an example washing apparatus in an assembled form ready for use, in accordance with aspects of the present disclosure;

FIG. 2 is a perspective exploded view of the example washing apparatus of FIG. 1, in accordance with aspects of the present disclosure;

FIG. 3 is a perspective exploded view of an example filter and paddle, in accordance with aspects of the present disclosure;

FIG. 4 is a detailed view of FIG. 3, as called out in FIG. 3, illustrating the circular end of the paddle, in accordance with aspects of the present disclosure;

FIG. 5 is a perspective view of an example filter, in accordance with aspects of the present disclosure;

FIG. 6 is a section view of FIG. 5, in accordance with aspects of the present disclosure;

FIG. 7 is a detailed view of FIG. 6, illustrating the filter and its nesting point for the paddle, in accordance with aspects of the present disclosure; and

FIG. 8 is another view of the washing apparatus of FIG. 1 in the assembled form, illustrating the internal structural details, in accordance with aspects of the present disclosure;

FIG. 9 is a perspective view of an example paddle, in accordance with aspects of the present disclosure;

FIG. 10 is a front-side view of another example paddle, in accordance with aspects of the present disclosure;

FIG. 11 is a perspective view of an alternative example paddle, in accordance with aspects of the present disclosure;

FIG. 12 is a bottom side view of an example gear reduction system built into the lid of the washing apparatus, in accordance with aspects of the present disclosure; and

FIG. 13 is a cutaway side view of an example gear reduction system built in the lid of the washing apparatus, in accordance with aspects of the present disclosure.

FIG. 14 is a perspective view of an alternative paddle, in accordance with aspects of the present disclosure.

### DETAILED DESCRIPTION

For clarity and simplicity, the present specification may refer to structural and/or functional elements, relevant standards, and other components, methods and/or processes that are commonly known in the art without further detailed explanation as to their configuration or operation except to the extent they have been modified or altered in accordance with and/or to accommodate the preferred and/or other embodiment(s) presented herein. Moreover, the apparatuses and methods disclosed in the present specification are described in detail by way of examples and with reference to the figures. Unless otherwise specified, like numbers in the figures indicate references to the same, similar or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific materials, techniques, arrangements, etc. are either related to a specific example presented or are merely a general description of such a material, technique, arrangement, etc. Identifications of specific details or examples are not intended to be, and should not be, construed as mandatory or limiting unless specifically designated as such. Selected examples of apparatuses and methods are herein after disclosed and described in detail with reference made to the figures.

In accordance with aspects of the present disclosure, a washing apparatus may be configured to clean, agitate and/or wash rice or any selected food item(s) in preparation of later cooking and/or consumption. In one embodiment, the main components of the apparatus may include a container, a strainer, a spatula or paddle, a lid, and a handle. The strainer may sit inside of a glass or plastic container, the paddle may sit inside of the strainer. When assembled, the paddle may be configured to nest in the strainer, and by pressure and/or geometry held in place, vertically, by the lid. The handle may be connected to the paddle through a hole in the lid. The handle may be rotated, or spun, 360 degrees continuously by a user.

The disclosed washing apparatus simplifies a food washing process, typically done by hand, by creating a method of agitation between a selected food item(s) and the paddle. For example, one may pour rice into the strainer alongside the paddle, and place the strainer into the container, then water is poured into the container. The lid is then attached to the container, then the handle attached to the paddle. By then rotating the handle multiple times, the rice is subsequently agitated and cleaned by the surrounding water. When the paddle is rotated continuously for a period of time (e.g., several minutes or any selected duration of time), the water may become cloudy. It can be appreciated that rice may be substituted for any other food such as beans, lentils, or vegetables that may need cleaning.

Once finished washing, the handle and lid may be removed from the paddle and container, respectively, and the strainer containing the rice, removed from the container still filled with water. At this point, the water may be drained from the container and refilled if necessary to further wash the rice. If the user wanted to further clean the rice, the strainer may be reinserted into the container, fresh water added, lid and handle attached, and the user may make multiple further rotations of the handle to clean the rice. It should be noted that by using the washing apparatus, the amount of water needed to clean rice is significantly reduced when compared to traditional rice washing methods done by hand. If rice is agitated for multiple minutes using the washing apparatus, the water, or solvent, contains high amounts of dissolved rice starch, or solute, more than would typically be seen in traditional rice washing methods done by hand. Hand washing methods typically require multiple rounds of washing, or a continuous stream of water, resulting in more water consumed and wasted compared to the disclosed washing apparatus.

When the user is ready to begin cooking the rice, the handle is detached, the lid is to be unscrewed and/or removed from the container, and the strainer may be separated from the container. The strainer, still containing the rice, and paddle, may be brought over to the intended cooking vessel, such as, but not limited to a pot or rice cooker. The paddle may be removed over the pot or rice cooker, and strainer contents-rice or other food-emptied into the pot. In one aspect, the paddle may be used as a spatula to dislodge any lingering pieces of food or rice grains into the intended cooking vessel. In this manner, no grains are wasted, and all are transferred into the intended cooking vessel. In some embodiments, the strainer may telescope and/or collapse to easily allow rice grains that are sticking or adhering on the bottom of the strainer to be pushed out of the strainer or removed. Alternatively, the bottom of the strainer may be on a rail allowing it to move to the opening to push all of the rice out of the strainer. It should be noted that the lid, strainer, and paddle may be made of non-stick materials—plastic, metal or other—or coated in a non-stick material, which may prevent rice grains from adhering to any surfaces that it may come in contact with. Similarly, the strainer, or colander, may be made of a tight mesh, metal, plastic or other suitably perforated material, which allows for the drainage of water, but prevents rice grains from being caught in the filter or passing through the filter. Depending on the intended food to be washed, the strainer may be of varying shapes and sizes, and additionally made of different sizes of mesh, or varying porosity of the strainer. Once the rice has been transferred to the intended cooking vessel, it can be filled with water and cooked as desired. This might include cooking techniques such as steaming and/or boiling.

The container, strainer, lid, paddle and handle, can all be rinsed, hand washed as necessary, or inserted into a dishwasher for cleaning. All components of the washing apparatus can be made from dishwasher safe materials such as plastic, metal, glass, silicone, or other suitable dishwasher safe materials. Similarly, antimicrobial material may also be used to make the washing apparatus.

The container can be easily stored in a kitchen cabinet. In some embodiments the container may be collapsible, be made of silicone, plastic, other material, or a combination of multiple that allow it to telescope and/or collapse or fold in on itself for more efficient storage. The strainer may similarly be collapsible such that it is also easily storable and may be stored inside of the container when it is respectively in its collapsed and stored form. The individual pieces of the washing apparatus can be reused for multifunctional purposes if desired. The container, strainer, and lid can hold other liquids or solids other than water for washing foods. Suitably, the container can be used to store the leftover water from the food washing process to water plants or wash hair or any other inventive use for water. Additionally, the paddle can be used as, but not limited to a spatula.

It should be noted that the intended user may have multiple containers for washing rice, allowing them to remove the strainer, and paddle, and save the leftover water from the rice washing process. Additionally, a user may have multiple strainers along with multiple containers, allowing them to soak and/or sprout their rice or food in the washing apparatus, without the need for a paddle and/or multiple paddles.

In some embodiments, the container may be made of non-slip materials, or lined with a non-slip material such as, but not limited to rubber or plastic, to prevent the movement of the container when using the washing apparatus on a slick surface. In some other embodiment, all components of the washing apparatus, lid, handle, paddle, container, and strainer, may have specific sides of their surfaces non-slip to prevent their movements during assembly.

In accordance with aspects of the present disclosure, the paddle may have multiple shapes and/or designs that create optimal mixing and agitation. Additionally, the shape and form of the design may change to allow for a greater volume of rice or foodstuff, and may include a mechanized crank system in the case of industrial food washing. These designs include, but are not limited to holes, slits, slots, fingers, finger-like-shapes, and/or other patterns cut into the paddle. In some embodiments, the paddle and/or its mixing surface may be wider or taller or of varying shapes and sizes in reference to the strainer as to create optimal mixing between the food being washed and the surrounding liquid, or solvent. The paddle may have an inner core/shaft made of metal, plastic, wood or other suitably rigid material, while the bottom portion of the paddle used for mixing may be made of plastic, silicone, and/or other rigid and/or flexible, or semi-flexible materials, as to prevent the damage of rice grains when turned and mixed amongst the food. Alternatively, the paddle may be made of two materials with a denser core of one material and dipped and/or encapsulated by another material. The paddle may also lock, mechanically, magnetically, or in a similarly suitable method, into place to ensure a proper placement within the strainer. In one preferred embodiment, the paddle may be made of one material, such as metal, and lined on its edges with another material, such as plastic, or another suitable material. Additionally, the paddle may resemble shapes such as, but not limited to, impellers, agitators, propellers, blades, homogenizers or turbines. In this way, in some embodiments, the paddle or agitator may sit inside, outside, above, or below the strainer to create optimum mixing.

Additionally, in certain embodiments, measurements may be added to either the inside or outside of the strainer to measure the contents of the food to be washed. These markings may be added to the paddle. Measurement markings may also be added to the container to measure the amount of water, or solvent, added to the container and strainer. Similarly, a counter may also be added to the handle or lid of the washing apparatus to count the number of rotations the user had input into the device.

In one embodiment, the container may be a rice cooker or pot or pan used to cook rice. This may reduce the number of containers used in the cooking process—the need for the container and a cooking pot. For example, the strainer may contour to the shape of the rice cooker or pot and may nest within it. The paddle, lid and handle may work to agitate rice inside of the strainer, and may be attached to the top of the rice cooker or pot.

In yet another embodiment, a motor and/or gear reduction system may be used to complement or substitute the manual rotation of the handle. Subsequently, for every rotation the user and/or motor may input into the washing apparatus, the gearing may multiply and/or generally increase the number of turns performed by the paddle. Specifically, a user may turn on the motor, and the paddle may be rotated without the need for any manual turning of a handle. A gear reduction system may be used to alleviate the amount of turning necessary, thereby increasing the number of paddle rotations per handle turn, or similarly turns via a motor. In one aspect, the motor may be installed either on the top or bottom of the container, and thus may drive rotations of the paddle inside of the strainer. In an alternative embodiment, an impeller driven by the motor is used to agitate the water.

In another embodiment, a gear reduction system may be driven by a pump action linearly reciprocating drive with a shaft, which may drive the gearing system to turn a paddle, effectively converting the linear movement of the shaft into the rotary movement of the paddle. The user may press on the pump, driving a shaft or screw shaft, which may drive a gear to turn the paddle or directly drive the paddle, a spring then returns the shaft back to the return position.

In one exemplary embodiment, a motor and/or rice washing apparatus may be installed as a part of a rice cooker, allowing the user to wash and cook the rice inside the same bowl, and lower effort by use of a motor. In an additional embodiment, the washing process may be automated and scheduled as a part of the cooking process and/or programming of the rice washer. In a preferred embodiment, an inlet and/or opening for additional water and an exit and/or outlet for waste water may be implemented. As such, the user may connect the rice washer's inlet to a sink, or alternatively connect a pipe, other plumbing or an additional container to the inlet, allowing the user to easily fill the primary container with water. When the user has completed washing, the container's exit valve or other opening may be opened to easily drain the container of water. Similarly, a pipe or other plumbing may be connected to the container's exit to easily drain the water.

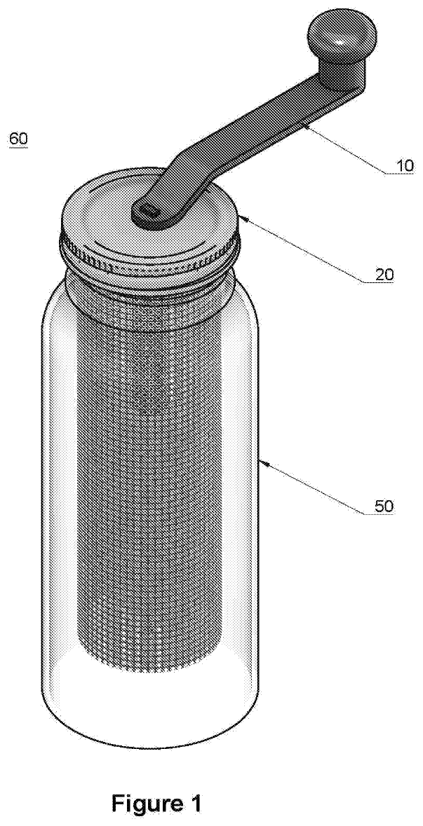

FIG. 1 illustrates an exemplary rice washing apparatus 60 in its assembled state, in accordance with aspects of the present disclosure. When viewed in the assembled state, the exposed components may include a handle 10, lid 20, and water container 50.

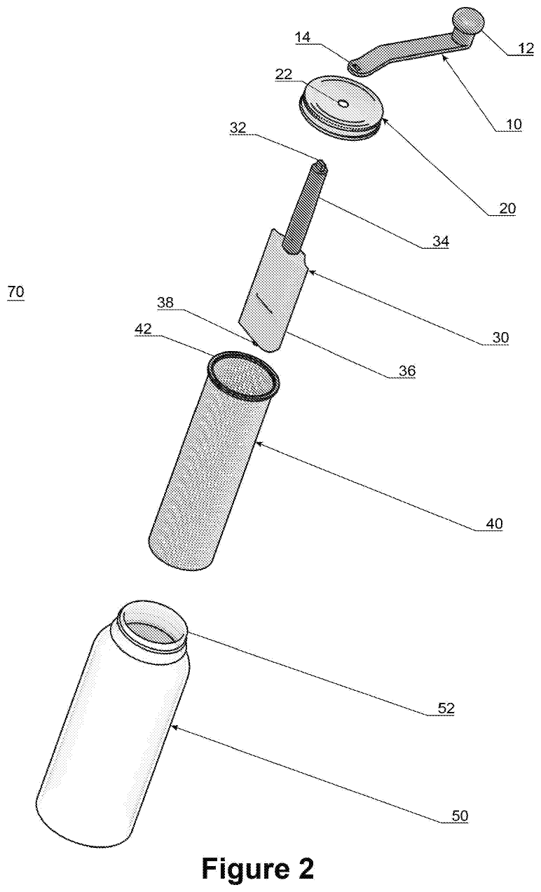

In reference to FIG. 2, a washing apparatus of the present disclosure is viewed in its disassembled state 70. There are five main components of the washing apparatus, the handle 10, the lid 20, the paddle 30, the strainer 40, and the container 50. The lip 42 of the strainer 40 may be configured to be larger than the opening diameter or rim of the container 52, such that the strainer 40 may nest inside of the container 50. The strainer 40 may be of equal or slightly less depth to container 50 as to create optimum food to water ratios, but strainer 40 may alternatively be of varying depth depending on the amount of rice to be washed. The strainer 40 may float freely on the rim of the container 50. Alternatively, in another embodiment, the strainer may be seated in a fixed position through grooves and/or shapes in the lip of the strainer 42 which align with grooves on the lip of container 52. The lip of the strainer 42 may be covered by a gasket to prevent rotational movement and create a seal between strainer 40 and container 50.

Paddle 30 may nest inside of the strainer 40. The paddle 30 may be of equal or greater length to the strainer. 40 to facilitate turning and rotation, it may then allow square peg protrusion 32 to pass through lid 20. The width of the paddle 30 may be of equal or slightly less than equal width to the diameter of the strainer 40, in order to maximize mixing potential, but limit friction between the paddle 30 and strainer 40. The gap may also be less than the size of a grain of rice as to prevent grains from becoming trapped between the paddle 30 and strainer 40.

The lid 20 may attach to container 50. The lid 20 may be secured tightly by a screw top to the container 50 as seen in FIG. 1. As lid 20 is screwed into place on container 50, it fixes strainer 40 in place on top of container 50 as well. Lid 20 may be lined internally with a gasket to prevent leaking and further seal lid 20 to container 50. Paddle 30 may be held into place by pressure and/or geometry from the lid 20 on paddle shaft 34. In one embodiment, the paddle 30 may be configured to have a square peg protrusion 32 which protrudes through lid hole 22. The paddle 30 attaches to handle 10 via the square peg 32 to the square hole 14 in handle 10. The user can then hold on to the handle 10 via an ergonomic handle 12. The length of handle 10 may be greater than four inches and less than twelve inches, to ensure enough spacing from container 50 such that the hand of the user does not get close to knocking the container, providing enough of a moment arm to aid in mixing, but not long enough to be exaggerated or excessive. The handle 12 may be of varying size, but creates enough of a handhold to allow the user to easily grip it. The dimensions of the square hole 14 are slightly greater than that of the square peg protrusion 32 to ensure proper nesting and minimize play between the two parts. When handle 10 is rotated 360 degrees, so is paddle 30. In an alternative embodiment, alternative shapes such as ovals, triangles, et cetera are used in lieu of the square peg protrusion 32 and square hole 14 to lock paddle 30 to handle 10.

When in the process of cleaning rice or other foods, the user may insert the strainer 40 into the container 50, and then add the paddle 30 into the strainer 40. The user may then pour the desired amount of rice into the strainer 40. Water may then be poured into the strainer 40, which may pass through the rice and strainer to subsequently fill the container 50. Once filled with the desired amount of water, the lid 20 may be screwed on, or attached tightly enough as to prevent splashing of water when paddle 30 is rotated. Finally, handle 10 may be attached to paddle 30, and the user can begin washing rice.

When the user is done washing their rice, handle 10 may be removed from the paddle 30, and lid 20 unscrewed from the container 50. Thereafter, strainer 40, which still contains paddle 30 and the rice, may be removed from container 50. The remaining water in container 50 may be saved for other uses or disposed of down the sink. The strainer 40 may be brought to the intended cooking vessel, such as a pot or rice cooker, and paddle 30 may be used to scrape, brush and/or move all grains of rice from strainer 40 into the pot via the mixing surface or wide end of the paddle 36. The disassembled pieces of the rice washer 70 may then be washed by the user for future uses.

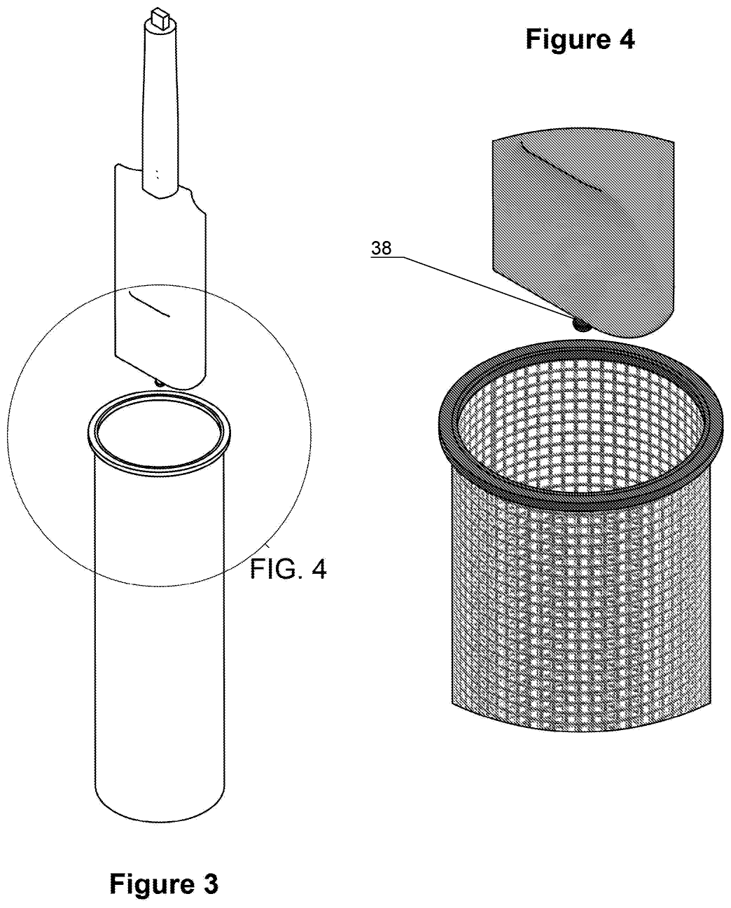

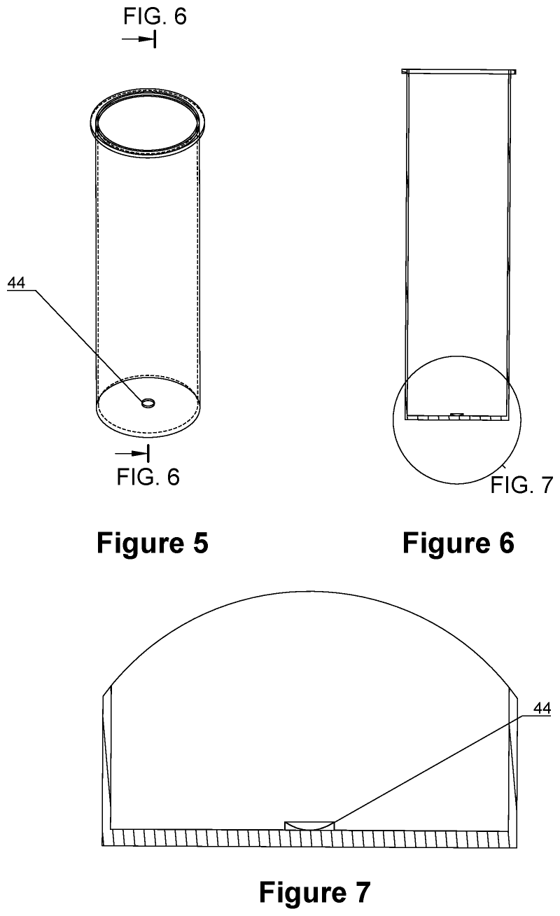

In reference to FIG. 3, particular attention is brought to the bottom end of the paddle 38, which is then seen in FIG. 4. In FIG. 4, the bottom of the paddle 38, which may be directly connected to shaft 34, may form a half sphere which is intended to nest in the bottom of the strainer 40 which is depicted in FIG. 5, FIG. 6, and FIG. 7, the nesting point 44, is a concave half circle allowing the paddle 30 to be held in place while rotating. In one embodiment the bottom of the paddle 38 is slightly less or equal to in radius than the radius of the bottom of the strainer 44, this ensures mating between the two spherical shapes and proper placement between paddle 30 and strainer 40. In one embodiment, the bottom of the paddle 38 may be less than two centimeters in depth, but provides enough depth to provide a proper fit between the mating pieces. In one ideal embodiment, the bottom of the paddle 38 and the bottom of the strainer 44 are magnetic, thus helping the user properly mate the two pieces. This thus provides both a mechanical as well as magnetic means of locking the parts into place and ensuring the continued alignment of paddle 30 and strainer 40 during usage and rotation. It can be appreciated that while the bottom of the strainer 44 may protrude from strainer 40, in an alternative embodiment, the nesting point 44 may be recessed into strainer 40 and/or flush with the bottom surface. Alternatively, in one embodiment the protrusion may come from the bottom of the strainer, and mate and/or nest with a recess in the bottom of the paddle.

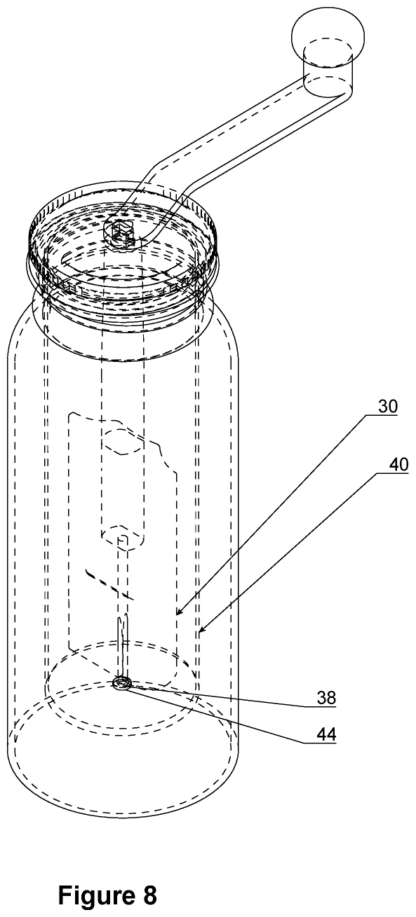

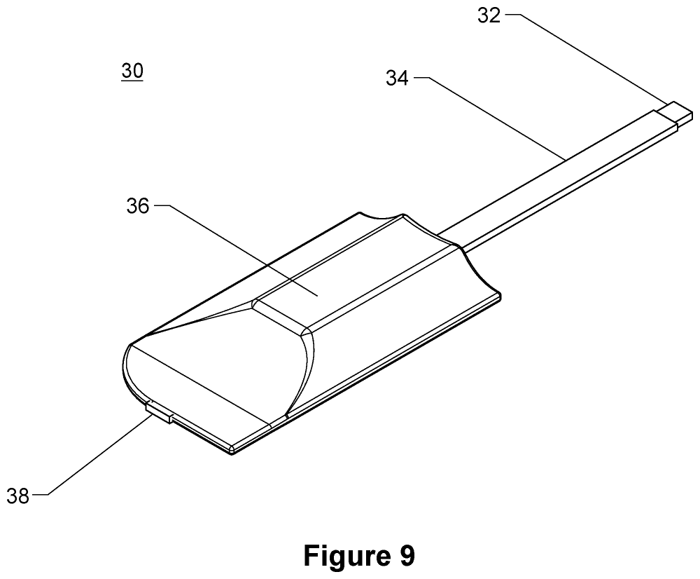

As depicted in FIG. 8, it can be seen through the hidden lines, that the paddle 30 comes to an end which is a half sphere 38, which nests in the concave fitting 44 of the strainer 40.

FIG. 9 illustrates a design of paddle 30. While FIG. 2 illustrates a circular shaft, FIG. 9 uses a rectangular shaft 34, allowing for less material to be used in its manufacture, while a circular shaft may be more appealing from an ergonomic perspective for its use as a spatula. Shaft 34 may protrude all the way through the bottom of mixing surface 36 to expose the bottom of paddle 38. It can be seen that the bottom of the paddle 38 is a rectangular shape, in this way, the bottom of the strainer 44 would respectively change shape to mate with this alternative design. The top of the spatula 32 is still a rectangular shape allowing the attachment of handle 10 via attachment point 14. Lid hole 22 may be covered with a gasket and/or cross-slit valve made of silicone and/or another food safe material to limit water splashing through the hole when paddle 30 is rotated.

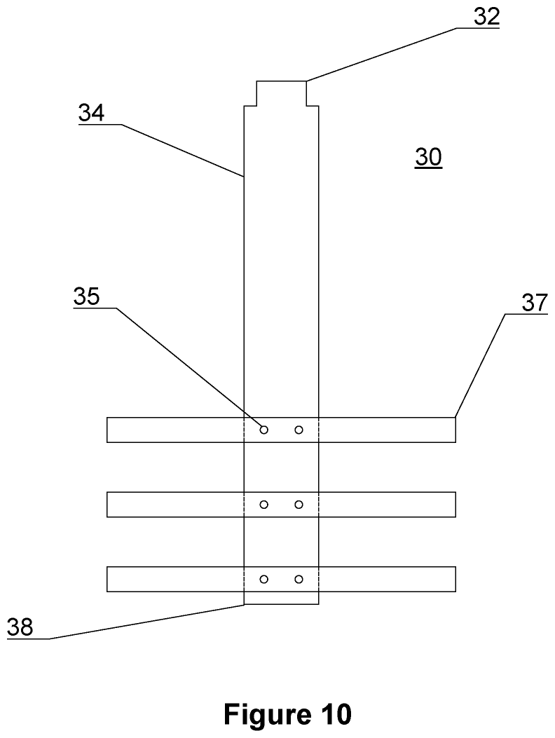

FIG. 10 illustrates an alternative design of paddle 30. The design of mixing surface. 37 may mimic that of human fingers, and may be made of silicone, plastic, or other similarly durable and soft material. Shaft 34 may have holes 35 and rivets inserted to ensure the mixing surfaces 37 are secured in place to ensure minimal to no play occurs when mixing is initiated. Attachment point 32 may allow handle 10 to be attached. As with FIG. 9, the end point of the paddle 38 would allow for mating to the bottom of strainer 44.

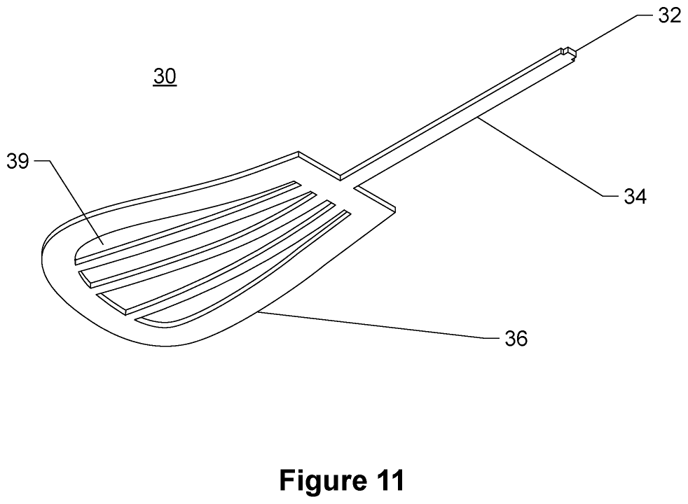

FIG. 11 illustrates alternative design of paddle 30. It can be seen that paddle 30 may suitably include holes 39 in mixing surface 36 to further optimize mixing of rice or other foods. Additionally, mixing surface 36 may optionally include designs or sweeping features in its shape.

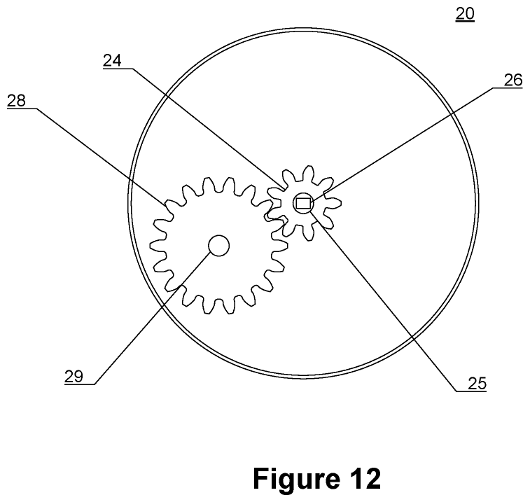

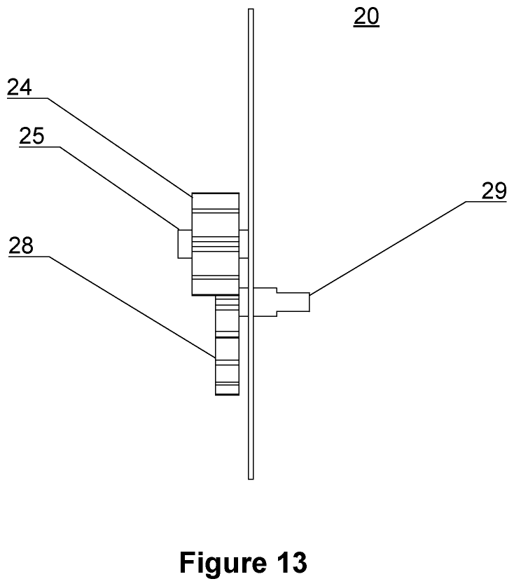

FIG. 12 illustrates a simple gear reduction design added to the lid 20 of the washing apparatus. Gear 24 may attach to shaft 25 that is aligned in the center of lid 20. Shaft 25 may have a shape such as a square or rectangle 26 cut into it which would allow for paddle 30 to be attached by its attachment point 32 to the shaft attachment point 26. Gear 28 may be attached to shaft 29. In FIG. 13 it can be seen that shaft 29 may have a square, rectangular or other attachment point that protrudes enough that handle 10 may be attached via attachment point 14. Thus when gear 28 is turned via shaft 29 by user input through handle 10, gear 24 is subsequently turned. For each full rotation of gear 28, gear 26 may rotate twice. Shaft 25 is subsequently rotated at the same rate as gear 26, and when paddle 30 is attached, it is rotated at the same rate. The gearing helps to alleviate the amount of effort that the user needs to input via handle 10 to turn paddle 30, compared to if such a gearing were not to be implemented. It can be appreciated that a motor may easily be attached to shaft 29 to drive gear 28 rather than a user. In some embodiments the gearing ratio may be changed, or additional gears added due to the size of the washing apparatus or more desirable ratios. The gears and shafts of the lid 20 may be made of food safe materials such as metal or plastic.

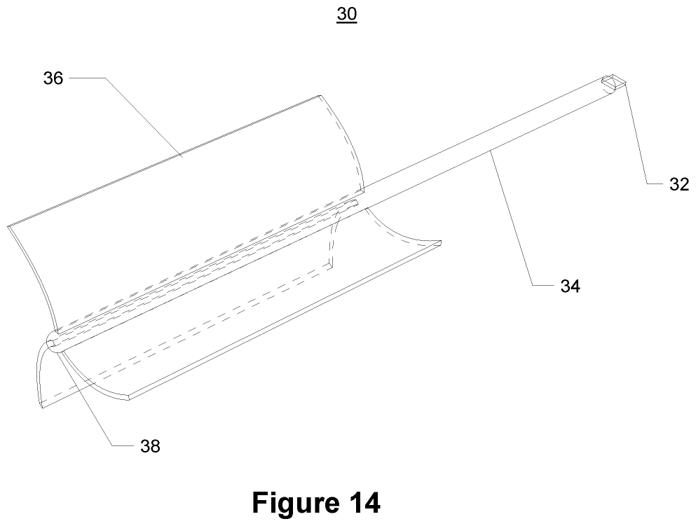

FIG. 14 illustrates another alternative embodiment of paddle 30. Mixing surface 36 may mix in multiple planes as to further optimize mixing and washing of food. The mixing surface 36 may be made of a semi rigid material in order to maintain its curved shape while mixing, but be flexible enough as to not damage the rice or food during washing. Mixing surface 36 is attached to shaft 34. The height of the mixing surface 36 in proportion to the shaft 34 may be of varying length depending on the size of the washing apparatus and amount of food to be washed. Shaft 34 terminates in end point 38 which would mate with strainer 40 via the concave nesting point 44. Shaft 34 is also connected to the square attachment point 32 which would connect to handle 10 via square hole 14.

Although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. An apparatus, comprising:
a container configured to be filled with water;
a strainer configured to be inserted into the container and filled with a selected food item to be cleaned;
a paddle configured to be inserted into the strainer for agitating the selected food item,
a lid with a hole attached to a top of the container to seal itself while exposing the top of the paddle; and
a handle configured to attach to the top of the paddle to allow the paddle to rotate inside the strainer.

2. The apparatus of claim 1, wherein the container, strainer, paddle, lid and handle are dishwasher safe.

3. The apparatus of claim 1, wherein the paddle comprises an inner core made of a rigid material and an outer portion made of a flexible material to prevent damage to the selected food item during agitation.

4. The apparatus of claim 1, wherein the strainer or container further comprises of measurement markings on either the inside or outside surface to measure an amount of food to be washed.

5. The apparatus of claim 1, wherein the handle comprises a counter to count the number of rotations performed by a user.

6. The apparatus of claim 1, further comprising a non-slip material lining a surface of the container to prevent movements during rotation.

7. The apparatus of claim 1, further comprising a gear reduction system configured to drive rotations of the paddle inside the strainer.

8. The apparatus of claim 1, further comprising a motor and a gear reduction system configured to drive rotations of the paddle inside the strainer, wherein the motor is operable by a user.

9. The apparatus of claim 1, wherein the lid, strainer, and paddle are made of non-stick materials or coated in a non-stick material to prevent food particles from adhering to their surfaces.

10. The apparatus of claim 1, wherein the strainer is telescopically collapsible to facilitate the removal of residues or particles of the selected food item sticking to the bottom of the strainer.

11. The apparatus of claim 1, wherein the strainer is shaped to contour and nest within a rice cooker or a cooking pot.

12. The apparatus of claim 1, further comprising an inlet for adding water and an outlet for draining waste water, the inlet and outlet being connectable to plumbing for easy filling and draining of the container.
